(19) United States
(12) Patent Application Publication
(10) Pub. No.: US 2024/0393157 A1
(43) Pub. Date: Nov. 28, 2024

(54) METHODS AND SYSTEMS FOR ENHANCING WELL FLOW RATE SIGNAL

(71) Applicant: SAUDI ARABIAN OIL COMPANY, Dhahran (SA)

(72) Inventors: Abdullah Al Ghazal, Dhahran (SA); Ahmed Al Shaikh, Dhahran (SA)

(73) Assignee: SAUDI ARABIAN OIL COMPANY, Dhahran (SA)

(21) Appl. No.: 18/323,204

(22) Filed: May 24, 2023

(51) Int. Cl. G01F 15/02; E21B 41/00; G01F 1/74

(52) U.S. Cl. CPC G01F 15/024; E21B 41/00; G01F 1/74

(57) ABSTRACT

A method to enhance flow rate data that includes receiving flow rate data that includes a plurality of data values from a device measuring a flow rate of a fluid in a pipeline. The method further includes identifying and correcting erroneous data values with a flow rate signal enhancement system configured to determine a plurality of delta values and to detect discontinuities in the flow rate data by comparing the plurality of delta values to a continuity threshold. The flow rate signal enhancement system is further configured to correct data values associated with detected discontinuities with an interpolation method and identify erroneous data values. The flow rate signal enhancement system is further configured to determine a condition of the pipeline associated with each identified erroneous data value, correct erroneous data values based on the condition of the pipeline, and compile enhanced (corrected) data flow rate data.

### BACKGROUND

The extraction and production of oil and gas from a well, or an oil and gas field composed of at least one well, is a complex process. The production properties of a reservoir, accessed by one or more well, will change over time. For example, reservoir production may change due to falling pressure and increased water content. Over the lifecycle of the oil and gas field many decisions will be taken in order to meet both short- and long-term production goals and extend the life cycle of a well.

Further, as oil, gas, and water are produced from a well, they typically flow as a non-homogeneous mixture of phases through a pipeline from the wellhead to a separator. Phase flow rate data are essential for reservoir monitoring and production optimization. Phase flow rates often determined or predicted using a test separator, a multiphase flow meter (MPFM), and/or a virtual flow meter (VFM). Regardless of how the phase flow rate data is acquired, often the phase flow rate data, or the signals and other process data used to determine the phase flow rate data, contains erroneous values over intermittent time periods. To improve the monitoring of wells, optimize production, and inform operation and life cycle management decisions, there exists a need to detect and correct faulty phase flow rate data.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Embodiments disclosed herein generally relate to a method to enhance flow rate data. The method includes receiving flow rate data that includes a plurality of data values from a device measuring a flow rate of a fluid in a pipeline and receiving process variable data. The method further includes identifying and correcting erroneous data values with a flow rate signal enhancement system. The flow rate signal enhancement system is configured to determine a plurality of delta values by taking the difference of temporally adjacent data values and detect discontinuities in the flow rate data by comparing the plurality of delta values to a continuity threshold. The flow rate signal enhancement system is further configured to correct data values associated with detected discontinuities with an interpolation method and identify the erroneous data values. The flow rate signal enhancement system is further configured to determine a condition of the pipeline associated with each identified erroneous data value by evaluating the process variable data, correct erroneous data values based on the condition of the pipeline, and compile unaltered data values and corrected data values into enhanced data flow rate data. The method further includes determining a daily production of hydrocarbons in the pipeline based on the enhanced data flow rate data.

Embodiments disclosed herein generally relate to a non-transitory computer readable medium storing instructions executable by a computer processor, where the instructions include functionality for receiving flow rate data that includes a plurality of data values from a device measuring a flow rate of a fluid in a pipeline and receiving process variable data. The instructions further include functionality for determining a plurality of delta values by taking the difference of temporally adjacent data values and detecting discontinuities in the flow rate data by comparing the plurality of delta values to a continuity threshold. The instructions further include functionality for correcting data values associated with detected discontinuities with an interpolation method and identifying erroneous data values. The instructions further include functionality for determining a condition of the pipeline associated with each identified erroneous data value by evaluating the process variable data, correcting erroneous data values based on the condition of the pipeline, and compiling unaltered data values and corrected data values into enhanced data flow rate data. The instructions further include functionality for determining a daily production of hydrocarbons in the pipeline based on the enhanced data flow rate data.

Embodiments disclosed herein generally relate to a system that includes an oil and gas field and a flow metering device coupled, physically or virtually, to a pipeline in the oil and gas field, where the flow metering device measures a flow rate of a fluid in the pipeline and outputs the measured flow rate as flow rate data. The system further includes a computer communicably connected to the flow metering device. The computer includes one or more computer processors and a non-transitory computer readable medium storing instructions executable by a computer processor. The instructions include the functionality for receiving the flow rate data comprising a plurality of data values and receiving process variable data. The instructions further include functionality for determining a plurality of delta values by taking the difference of temporally adjacent data values and detecting discontinuities in the flow rate data by comparing the plurality of delta values to a continuity threshold. The instructions further include functionality for correcting data values associated with detected discontinuities with an interpolation method and identifying erroneous data values. The instructions further include functionality for determining a condition of the pipeline associated with each identified erroneous data value by evaluating the process variable data, correcting erroneous data values based on the condition of the pipeline, and compiling unaltered data values and corrected data values into enhanced data flow rate data. The system may further determine a daily production of hydrocarbons in the pipeline based on the enhanced data flow rate data.

Other aspects and advantages of the claimed subject matter will be apparent from the following description and the appended claims.

### BRIEF DESCRIPTION OF DRAWINGS

The following is a description of the figures in the accompanying drawings. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, shapes of the elements as drawn are not necessarily intended to convey any information regarding the actual shape of the elements and have been solely selected for ease of recognition in the drawing.

FIG. 1 depicts a pipeline in accordance with one or more embodiments.

FIG. 2 depicts a multiphase fluid flowing in a pipe in accordance with one or more embodiments.

FIG. 3 depicts a high-level overview of a system in accordance with one or more embodiments.

FIG. 4 depicts a flowchart in accordance with one or more embodiments.

FIG. 5 depicts example flow rate data and example enhanced flow rate data in accordance with one or more embodiments.

FIG. 6 depicts a neural network in accordance with one or more embodiments.

FIG. 7 depicts a flowchart in accordance with one or more embodiments.

FIG. 8 depicts a flowchart in accordance with one or more embodiments.

FIG. 9 depicts a flowchart in accordance with one or more embodiments.

FIG. 10 depicts a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “flow signal” includes reference to one or more of such flow signals.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

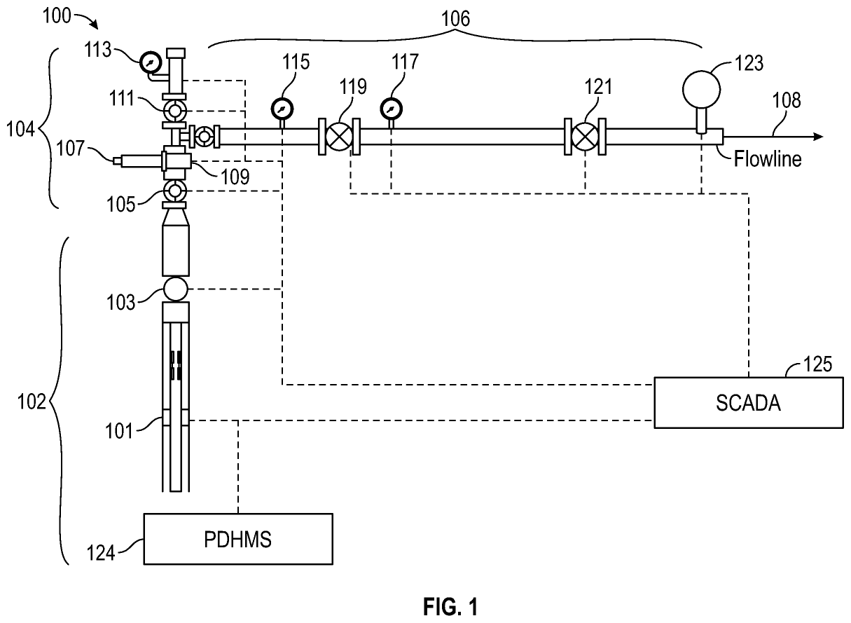

In the following description of FIGS. 1-13, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

Embodiments disclosed herein relate to methods and systems to detect and replace erroneous flow rate data, including multiphase flow rate data using a flow rate signal enhancement system. For example, an oil and gas field may consist of one or more wells each outfitted with one or more multiphase flow meters (MPFMs). An MPFM may malfunction, temporarily (i.e., briefly output incorrect values) or permanently (until repair or replacement), such that flow rate measurements at the location of the MPFM are either inaccurate or non-existent. In accordance with one or more embodiments, the flow rate signal enhancement system disclosed herein is configured to receive flow rate measurements (such as from a MPFM or virtual flow meter (VFM)), detect erroneous data, and correct or replace the erroneous data so that systems dependent on flow rate data (e.g., production monitoring systems) can accurately assess the state of pipeline, well, and/or oil and gas field.

The corrected, or enhanced, flow rate data may be output by the flow rate signal enhancement system and received by a system user or other system. For example, the enhanced flow rate data may be used by a reservoir simulator or subsurface model to optimize production of hydrocarbons from a well and/or oil and gas field. As such, accurate multiphase flow rate measurements from a well, or oil and gas field, are provided without interruption.

In accordance with one or more embodiments, FIG. 1 depicts a simplified portion of a pipeline (100) of a multilateral well in an oil and gas field. Herein, an oil and gas field is broadly defined to consist of wells which produce at least some oil and/or gas. Hydrocarbon wells typically produce oil, gas, and water in combination. The relative amounts of oil, gas, and water may differ between wells and vary over any one well's lifetime.

For clarity, the pipeline (100) is divided into three sections; namely, a subsurface (102) section, a tree (104) section, and a flowline (106) section. It is emphasized that pipelines (100) and other components of wells and, more generally, oil and gas fields may be configured in a variety of ways. As such, one with ordinary skill in the art will appreciate that the simplified view of FIG. 1 does not impose a limitation on the scope of the present disclosure. As part of the subsurface (102) section, FIG. 1 shows an inflow control valve (ICV) (101). An ICV (101) is an active component usually installed during well completion. The ICV (101) may partially or completely choke flow into a well. Generally, multiple ICVs (101) are installed along the reservoir section of a wellbore. Each ICV (101) is separated from the next by a packer. Each ICV (101) can be adjusted and controlled to alter flow within in the well and, as the reservoir depletes, prevent unwanted fluids from entering the wellbore.

The subsurface (102) section of the pipeline (100) has a subsurface safety valve (SSSV) (103). The SSSV (103) is designed to close and completely stop flow in the event of an emergency. Generally, an SSSV (103) is designed to close on failure. That is, the SSSV (103) requires a signal to stay open and loss of the signal results in the closing of the valve. Also shown as part of the subsurface (102) section is a permanent downhole monitoring system (PDHMS) (124). The PDHMS (124) consists of a plurality of sensors, gauges, and controllers to monitor subsurface flowing and shut-in pressures and temperatures. As such, a PDHMS (124) may indicate, in real-time, the state or operating condition of subsurface equipment and the fluid flow.

Turning to the tree (104) section of FIG. 1 is a master valve (MV) (105), a surface safety valve (SSV) (107), and a wing valve (WV) (109). The MV (105) controls all flow from the wellbore. For safety considerations, a MV (105) is usually considered so important that two master valves (MVs) (second not shown) are used wherein one acts as a backup. Like unto the SSSV (103), the SSV (107) is a valve installed on the upper portions of the wellbore to provide emergency closure and stoppage of flow. Again, SSVs (107) are designed to close on failure. One or more WVs (109) may be located on the side of the tree (104) section, or on temporary surface flow equipment (not shown). WVs (109) may be used to control and isolate production fluids and/or be used for treatment or well-control purposes.

Also shown in FIG. 1 is a control valve (CV) (111) and a pressure gauge (PG) (113). The CV (111) is a valve that controls a process variable, such as pressure, flow, or temperature, by modulating its opening. The PG (113) monitors the fluid pressure at the tree (104) section.

Turning to the flowline (106) section, the flowline (106) transports (108) the fluid from the well to a storage or processing facility (not shown). A choke valve (119) is disposed along the flowline (106). The choke valve (119) is used to control flow rate and reduce pressure for processing the extracted fluid at a downstream processing facility. In particular, effective use of the choke valve (119) prevents damage to downstream equipment and promotes longer periods of production without shut-down or interruptions. The choke valve (119) is bordered by an upstream pressure transducer (115) and a downstream pressure transducer (117) which monitor the pressure of the fluid entering and exiting the choke valve (119), respectively. The flowline (106) shown in FIG. 1 has a block and bleed valve system (121) which acts to isolate or block the flow of fluid such that it does not reach other downstream components. The flowline (106) may also be outfitted with one or more temperature sensors (123).

The various valves, pressure gauges and transducers, and sensors depicted in FIG. 1 may be considered field devices of an oil and gas field. As shown, these field devices may be disposed both above and below the surface of the Earth. These field devices are used to monitor and control components and sub-processes of an oil and gas field. It is emphasized that the oil and gas field devices depicted in FIG. 1 are non-exhaustive. Additional devices, such as electrical submersible pumps (ESPs) (not shown) may be present in an oil and gas field with their associated sensing and control capabilities. For example, an ESP may monitor the temperature and pressure of a fluid local to the ESP and may be controlled through adjustments to ESP speed or frequency.

The field devices may be distributed, local to the sub-processes and associated components, global, connected, etc. The field devices may be of various control types, such as a programmable logic controller (PLC) or a remote terminal unit (RTU). For example, a programmable logic controller (PLC) may control valve states, pipe pressures, warning alarms, and/or pressure releases throughout the oil and gas field. In particular, a programmable logic controller (PLC) may be a ruggedized computer system with functionality to withstand vibrations, extreme temperatures, wet conditions, and/or dusty conditions, for example, around a pipeline (100). With respect to an RTU, an RTU may include hardware and/or software, such as a microprocessor, that connects sensors and/or actuators using network connections to perform various processes in the automation system. As such, a distributed control system may include various autonomous controllers (such as remote terminal units) positioned at different locations throughout the oil and gas field to manage operations and monitor sub-processes. Likewise, a distributed control system may include no single centralized computer for managing control loops and other operations.

In accordance with one or more embodiments, FIG. 1 depicts a supervisory control and data acquisition (SCADA) system (125). A SCADA system (125) is a control system that includes functionality for device monitoring, data collection, and issuing of device commands. The SCADA system (125) enables local control at an oil and gas field as well as remote control from a control room or operations center. To emphasize that the SCADA system (125) may monitor and control the various devices of an oil and gas field, dashed lines connecting the plurality of oil and gas field devices to the SCADA system (125) are shown in FIG. 1.

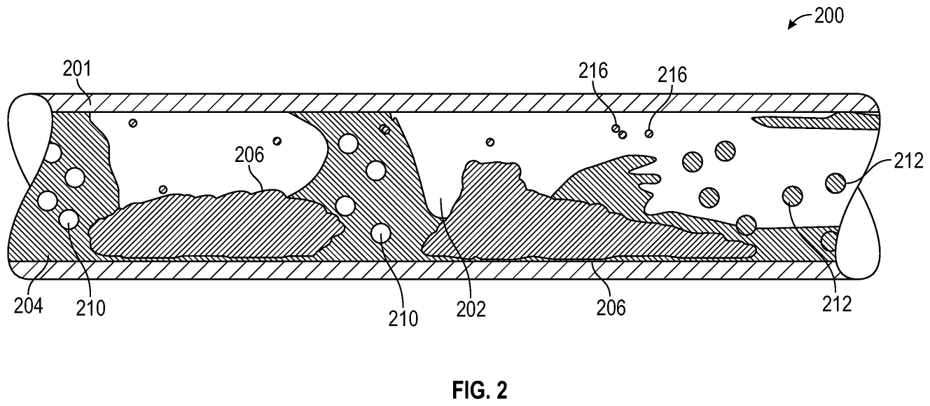

FIG. 2 depicts a simplified view of a cross-section of a flowline (106) carrying a multiphase fluid. As seen, the multiphase fluid may have multiple constituents such as gas (202), water (204), and oil (206). The various constituents of the multi-phase fluid may be distributed within the flowline (106) in a myriad of ways. As a non-limiting example, gas (202) may be enclosed by liquids (water or oil) forming bubbles (210). Or, in contrast, liquid droplets, such as oil droplets (216) and water droplets (212), may be dispersed in the gas (202) to form a mist. In general, the state of the multiphase fluid may be described using broad classifications. That is, the multiphase fluid may be categorized as “bubbly,” “annular,” “churn,” “mist,” “stratified,” or other designations (flow classes) based on the distribution of the constituents and their relative quantities. The state of the multiphase fluid may be transient such that any assignment of flow class may change with time.

Oil and gas field devices, like those shown in FIG. 1 (and others not shown), monitor and govern the behavior of the components and sub-processes of the well and/or the oil and gas field. Therefore, the productivity of the well and/or the oil and gas field is directly affected, and may be altered by, at least some, of the field devices. Generally, complex interactions between oil and gas field components and sub-processes exist such that configuring field devices for optimal production is a difficult and laborious task. Further, the state and behavior of oil and gas fields is transient over the lifetime of the constituent wells requiring continual changes to the field devices to enhance production.

To inform and optimize the settings of the field devices of a pipeline (100) to maximize hydrocarbon production, improve hydrocarbon accounting (i.e., determine the mass of hydrocarbons produced from a well), and increase production compliance, it is important accurately determine the phase flow rates of the multiphase flow. Traditionally, flow rate data is acquired through use of a variety of physical devices. These physical devices include test separators and multiphase flow meters (MPFMs). Test separators are used to split the multiphase fluid into single phases (e.g., gas, water, and oil). Upon splitting the multiphase fluid into single phases, the flow of each phase is measured using single-phase flow meters.

On the other hand, MPFMs estimate multiphase flow rates in real time without splitting the phases. As an example, the pipeline (100) depicted in FIG. 1 is outfitted with a multiphase flow meter (MPFM) (127). The MPFM (127) may detect the instantaneous amount of gas, oil, and water flowing in the pipeline (100). As such, the MPFM (127) can indicate additional quantities such as percent water cut (% WC) and the gas-to-oil ratio (GOR).

In general, a MPFM (127) cannot directly measure the flow rate of the individual phases in a fluid. Rather, a MPFM (127) is a collection of sensors, transmitters, mechanical devices, flow conduits, and programmed relationships that are used to determine the individual phase flow rates. In some instances, the use of a MPFM (123), or other metering device, on the pipeline (100) for each well in an oil and gas field may be prohibited by cost or other factors. Alternatively, in order to estimate the phase flow rate of a pipeline (100), physics-based models, phenomenological models, data-derived models, and/or empirical relationships may be used. Generally, these methods use quantities that are easier (e.g. accessibility) or cheaper to measure. Such quantities may be measured using the field instruments disposed throughout the pipeline which may be collected and monitored using a SCADA system (125). Devices or models that estimate the phase flow rates using readily available, or more easily accessible quantities may be generally classified as virtual flow meters (VFMs). Recently, VFMs have gained popularity in the oil and gas industry as they do not require physical installation and thus can reduce capital and operational costs while providing real-time measurements. In some instances, VFMs are used as a replacement of MPFMs or as back-ups and/or validators to MPFMs. However, a notable weakness of VFMs is that since they are often calibrated, trained, or tuned to specific flow regimes and/or historical datasets they tend not to extrapolate well beyond narrow operating conditions or flow conditions. As such, VFMs often experience “drift” over time, reducing their accuracy.

An understanding of phase flow rates is critical for proper management of an oil and gas field. Proper management includes activities and decisions to maximize hydrocarbon production, extend the lifetime of associated wells, accurately model reservoir capacity and conditions, accurately account for produced hydrocarbons, maximize hydrocarbon recovery, mitigate physical and financial risk, and reduce costs. As an example, if a flow rate meter reveals that the gas flow is less than expected given the current conditions of the well, it may indicate an issue, limitation, or constraint within the well or reservoir. Production operators and engineers use such indications, or other anomalies detected with a gas meter, to troubleshoot and correct the situation. For production operators and engineers, flow rate data are crucial to well surveillance and to understand the health of a network of wells in an oil and gas field. Further, precise and accurate phase flow rate estimates are significantly important from an economical perspective because even a minor estimation error could lead to substantial monetary losses when considering the large volumes of hydrocarbons undergoing custody transfer.

To measure phase flow rates, physical meters (e.g., MPFMs), VFMs, a test separator, and/or other flow rate measurement devices may be disposed, or otherwise employed, throughout an oil and gas field. Regardless of how the phase flow rate data is acquired, often the phase flow rate data, or the signals and other process data used to determine the phase flow rate data, contain erroneous values over intermittent time periods. To improve the monitoring of wells, optimize production, and inform operation and life cycle management decisions, there exists a need to detect and correct faulty phase flow rate data.

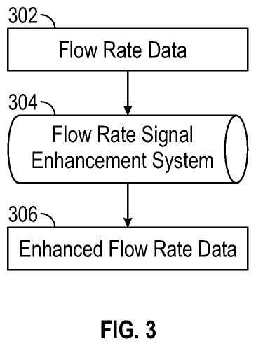

In accordance with one or more embodiments, a flow rate signal enhancement system (304) is configured to receive flow rate measurements (such as from a MPFM or virtual flow meter (VFM)), detect erroneous data, and correct or replace the erroneous data so that systems dependent on flow rate data (e.g., production monitoring systems) can accurately assess the state of pipeline, well, and/or oil and gas field. FIG. 3 provides a high-level overview of the use of the flow rate signal enhancement system (304). As seen in FIG. 3, flow rate data (302) is received and/or available. The flow rate data (302) may include single or multiphase measurements of a fluid flowing in a pipeline. In some embodiments, the flow rate data may not directly indicate the flow rate of a fluid (or its phases) but may represent one or more process variables used to determine the flow rate of a fluid. For example, in one or more embodiments the flow rate data consists of temperature and pressure measurements used by a VFM to estimate flow rate data. The flow rate data may be referred to as a flow rate signal without undue ambiguity.

Continuing with FIG. 3, the flow rate data (302) is received and processed by the flow rate signal enhancement system (304). Various embodiments of the flow rate signal enhancement system (304) are described in greater detail later in the instant disclosure. For now, with respect to the high-level overview, it is sufficient to say that the flow rate signal enhancement system (304) detects periods of erroneous data in the flow rate data (302) and replaces the identified periods with corrected values. Thus, the principal output of the flow rate signal enhancement system (304) is enhanced flow rate data (306), where the enhanced flow rate data (306) has any identified periods of erroneous data corrected with and/or replaced by accurate values.

In one or more embodiments, the enhanced flow rate data (306) is received by an external system such as a production monitoring system or reservoir simulator (not shown). For example, the enhanced flow rate data (306) may be used by a reservoir simulator or subsurface model to optimize production of hydrocarbons from a well and/or oil and gas field. As such, accurate multiphase flow rate measurements from a well, or oil and gas field, are provided without interruption.

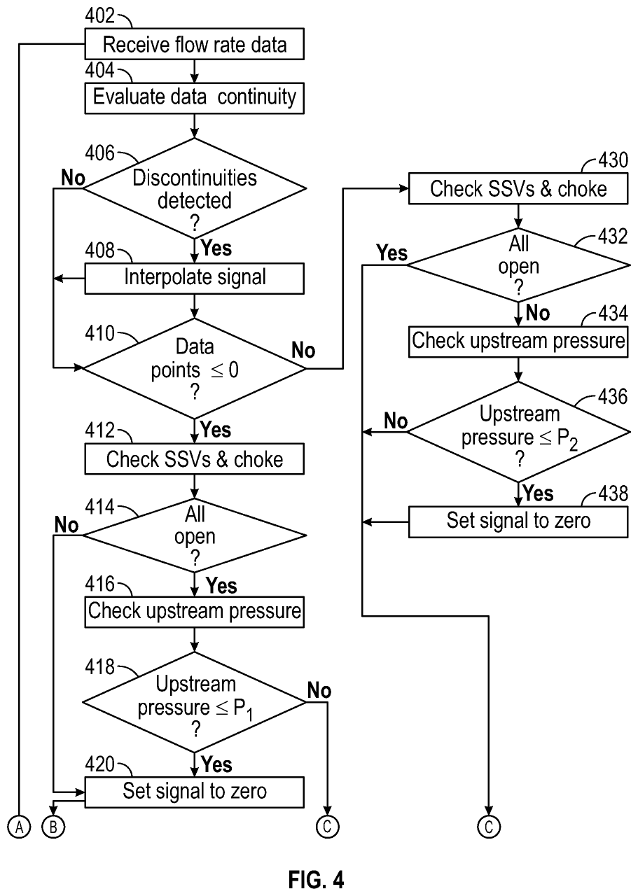

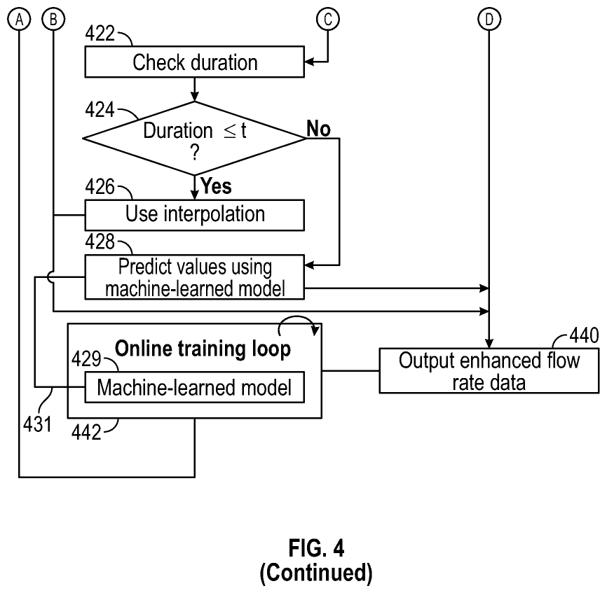

FIG. 4 depicts the steps implemented by the flow rate signal enhancement system (304), in accordance with one or more embodiments. As will be demonstrated, the flow rate signal enhancement system (304) detects and corrects erroneous flow rate data (302) through a combination of heuristics (i.e., hard-coded rules) and machine-learning. Machine learning, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term machine learning, or machine-learned, will be adopted herein, however, one skilled in the art will recognize that the concepts and methods detailed hereafter are not limited by this choice of nomenclature. More details regarding machine learning and its implementation by the flow rate signal enhancement system (304) are provided later in the instant disclosure.

Keeping with FIG. 4, in Block 402 flow rate data is received. In one or more embodiments, the flow rate data includes a measured or estimated flow rate of a fluid flowing through a pipeline. The measured or estimated flow rate may originate from one or more flow meters, such as a MPFM, a VFM, a test separator, or other device. The flow rate data may include a flow rate for a single phase or multiple flow rates for a multiphase fluid. Generally, the flow rate data includes data over recent time period of a pre-defined length. The pre-defined length need not be fixed and can be selected or altered by a user according to user needs. In one or more embodiments, the pre-defined length is one day. In one or more embodiments, the flow rate data received in Block 402 further includes process variable data. Process variable data includes data regarding the state of field devices and measurements acquired by field devices related to the pipeline where the flow rate data is intended to be enhanced by the flow rate signal enhancement system (304). The process variable data spans the same pre-defined length as the flow rate data. Process variable data may include, but is not limited to: the state of safety valves (e.g., surface safety valve (SSV) (107)); choke valve (119) settings; and pressure measurements (e.g., upstream pressure transducer (115)). In some embodiments, the process variable data may be considered separate and distinct from the flow rate data. For the purposed of FIG. 4, the flow rate data includes process variable data.

In Block 404, the flow rate data is evaluated for continuity. Specifically, the difference between all adjacent data points in the flow rate data is taken resulting in an array of delta values. Adjacency is determined according to the time stamps of the data points. That is, adjacent data points are temporally adjacent. As a concrete example, consider the case where the flow rate data consists of a measured single phase flow rate for a fluid over the course of one day where the flow rate is measured, or sampled, once every 5 minutes. In such a case, the flow rate data may be said to be composed of 288 flow rate measurements or data points. In one or more embodiments, the data points are contained in an array of data points, A. In general, each data point may be indexed such that the i^{th} data point may be referenced as pᵢ without ambiguity. Therefore, given N data points, A=[p₁, p₂, . . . , pᵢ, . . . , p_{N}]. Further, the data points are arranged in the data point array A such that data points pᵢ and pᵢ₊₁ are temporally adjacent for i=1, . . . , N−1. Using this notation, in one or more embodiments, the array of delta values A is defined as A=[p₂−p₁, p₃−p₂, . . . , pᵢ₊₁−pᵢ, p_{N}−p_{N-1}]=[Δ₁, Δ₂, . . . , Δ_{N-1}]. In other embodiments, when determining the array of delta values, the data point array may be padded with a fictional data point p₀ or p_{N+1} such that array of delta values contains N delta values. In Block 404, each delta value is compared to a continuity threshold, T. In one or more embodiments, the comparison is performed according to |→ᵢ|>T. That is, a check is performed on each delta value to determine if the absolute value of the delta value exceeds the continuity threshold T. In other embodiments, two continuity thresholds. Tₚₒₛ and T_{neg}, are provided. In these cases, each delta value is compared to either the positive continuity threshold Tₚₒₛ or the negative continuity threshold T_{neg} according to the sign of the delta value. This comparison is represented mathematically as

$$\{ \begin{matrix}{Δ}_{i} > {T}_{pos} & if sign ( {Δ}_{i} ) is positive or zero \\ {Δ}_{i} < {T}_{neg} & otherwise\end{matrix} .$$

In either case, the continuity threshold, or continuity thresholds, are pre-defined by a user. In other words, in one or more embodiments, the flow rate signal enhancement system (304) is configured by one or more continuity thresholds. A discontinuity is determined to exist at each delta value where the comparison returns a value of “True.”

In Block 406, a simple check is performed to determine if at least one discontinuity is detected in the flow rate data. If at least one discontinuity is detected, then the intervals of discontinuities, where an interval need only include one data point, and/or the intervals between discontinuities are replaced with interpolated values, as depicted in Block 408.

One with ordinary skill in the art will appreciate that any interpolation method known in the art may be employed to replace data point values over discontinuous intervals without exceeding the scope of this disclosure. Interpolation methods may include imputation methods (e.g., mean value replacement, nearest value replacement), linear interpolation, quadratic interpolation, and spline methods of any order (i.e., methods that take into account derivatives). Once the data points associated with or bounded by discontinuities are replaced with interpolated values, the flow rate signal enhancement system (304) proceeds to Block 410. In the case where no discontinuities are identified in the flow rate data, the flow rate signal enhancement system (304) likewise proceeds from Block 406 to Block 410.

In Block 410, each data point of the flow rate data is checked to identify data points with a value less than or equal to zero. In some instances, continuous intervals will contain data points with values less than or equal to zero. For each data point or interval with values less than or equal to zero, the state of the SSV (107) and the choke valve (119) are checked in Block 412. In accordance with one or more embodiments, the state of these valves is binary and can only take a value of “open” or “closed.” In other embodiments, the valves may be considered to be partially opened and the state of the valve may be defined using a number between zero and one indicating how open or closed the valve is, where zero indicates the valve is fully closed and one indicates that the valve is fully opened.

Continuing with FIG. 4, if at least one of the valves is in a closed state (Block 414), then the processes of the flow rate signal enhancement system (304) continue to Block 420. In Block 420, the data points with a value less than zero are set to a value of zero and those data points with a value of zero are retained at this value. These data points are considered corrected and are output with the remaining data points in Block 440 has enhanced data flow rate data.

If, in Block 414, the SSV (107) and choke valve (119) are both in the open state, then the upstream pressure is checked in Block 416. In Block 418, the upstream pressure is compared to a first pressure threshold, P₁. In one or more embodiments, the first pressure threshold is defined by a user. In one or more embodiments, the value of the first pressure threshold is 500 pounds per square inch (psi).

If the upstream pressure is found to be less than or equal to the first pressure threshold, the associated data points are set to zero in Block 420 and the data points are returned in Block 440. If, in Block 418, the upstream pressure is greater than the first pressure threshold, the duration of the interval of the affected data points is measured in Block 422. That is, to arrive at Block 422, there must be at least one interval of data points with values less than or equal to zero, the SSV (107) and choke valve (119) are determined to be open over this interval, and the upstream pressure is greater than the first pressure threshold. Block 422, which measures the duration, in time, of the interval is applied to all intervals of the flow rate data that meet the required conditions.

In Block 424, duration of the one or more intervals is compared with a duration threshold, t. In one or more embodiments the duration threshold is defined by a user. In one or more embodiments, the value of the duration threshold is 30 minutes.

If, in Block 424, the duration of a given interval is less than or equal to the duration threshold, the data points of the given interval are replaced according using an interpolation scheme in Block 426. Block 426 may use the same interpolation method as in Block 408. Intervals with interpolated data points are returned as enhanced in Block 440. If, in Block 424, the duration of a given interval is greater than the duration threshold, the data points of the given interval are replaced using the predicted output of a machine-learned model (429) in Block 428.

As seen in FIG. 4, the machine-learned model (429) is made available to, or connected to, Block 428 through the first connecting line (431). As will be discussed in greater detail below, the machine-learned model (429) is continuously trained using historical flow rate data and enhanced flow rate data in Block 442. Thus, the training of the machine-learned model (429) may be said to be “online.” In one or more embodiments, the machine-learned model (429) is tuned at the end of receiving flow rate data (Block 402) and outputting enhanced flow rate data (Block 440). In this case, the machine-learned model is updated with the latest batch of data received by the flow rate signal enhancement system (304) and the previous output of the flow rate signal enhancement system (304), where the output may use data points predicted by the current or previous version of the machine-learned model (429). In one or more embodiments, the machine-learned model (429) accepts, as an input, the flow rate data and returns predicted data points for identified intervals in the flow rate data. In one or more embodiments, the identified intervals are the intervals of data points that meet the conditions outlined in the flowchart of FIG. 4 to arrive at Block 428. In one more embodiments, the machine-learned model (429) further accepts, as an input, the process variable data, such as the state of valves and pressure measurements. Once the identified interval(s) of data points have been replaced with predicted values from the machine-learned model (429), these data points are returned as enhanced data points in Block 440.

Returning to Block 410, for intervals of data points or data points that have values greater than zero, the states of the SSV (107) and choke valve (119) are checked in Block 430. Block 432 evaluates the states, open or closed, of the SSV (107) and choke valve (119). If, in Block 432, both valves are considered to be in the open state, the associated data points are returned as enhanced data points in Block 440. Alternatively, in Block 432, when at least one of the SSV (107) and the choke valve (119) are determined to be in a closed state, the upstream pressure is check in Block 434. In Block 436, the upstream pressure is compared to a second pressure threshold, P₂. In some embodiments, the first pressure threshold and the second pressure threshold are the same. If, in Block 436, the upstream pressure is less than or equal to the second pressure threshold, the associated data points are returned as enhanced in Block 440. If, in Block 436, the upstream pressure is greater than the second pressure threshold, the associated data points are set to a value of zero in Block 438 and subsequently returned as enhanced in Block 440.

In summary, the flow rate signal enhancement system (304) receives flow rate data (Block 402), processes the flow rate data piecewise according to a set of conditions, and returns (or outputs) enhanced flow rate data. The set of conditions includes, but is not limited to: states of the SSV (107) and choke valve (119); and the upstream pressure. In one or more embodiments, the SSV (107), choke valve (119), and upstream pressure are received as process variable data where the process variable data spans the same period as the received flow rate data. In one or more embodiments, the flow rate signal enhancement system (304) is configured according to a set of configuration parameters. Configuration parameters may in include: a first pressure threshold, a second pressure threshold, and a duration threshold. Configuration parameters may be set by a user and may change with time and/or independent implementations of the flow rate signal enhancement system (304). It will be well understood by one with ordinary skill in the art that the processes depicted in FIG. 4 operate piecewise on the received flow rate data. Further, various instances of the flow rate signal enhancement system (304), with individualized configuration parameters and machine-learned model (429), may be employed to different pipelines.

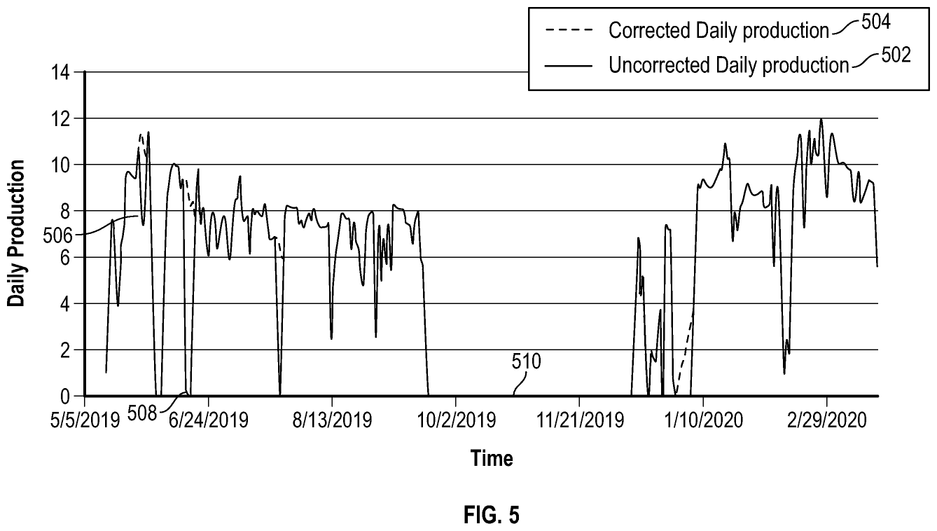

An example of the flow rate signal enhancement system (304) applied to a historical array of flow rate data (in terms of measured daily production) is depicted in FIG. 5. As seen, in the original, or uncorrected, daily production values (502) are plotted over a period of time. The uncorrected daily production values were processed by the flow rate signal enhancement system (304) according to the steps depicted in FIG. 4. For the present case, the flow rate signal enhancement system (304) outputs an array of enhanced, or corrected, daily production values (504) that is also plotted in FIG. 5. As seen in FIG. 5, the flow rate signal enhancement system (304) identified intervals of erroneous data, for example the first dip (506) and second dip (508) annotated in FIG. 5, and replaced the data points in those intervals with corrected values. The corrected values are determined using either interpolation or the machine-learned model (429). Notably, the flow rate signal enhancement system (304) did not try to correct or inject values into the historical array during a period of scheduled downtime (510). That is, the processes of the flow rate signal enhancement system (304) depicted in FIG. 4 are configured to intelligently identify erroneous data points without misidentifying correct data points in the original data set.

As discussed, in one or more embodiments, received flow rate data may be processed by a machine-learned model (429) in order to predict corrected values over one or more intervals identified as erroneous. Machine-learned model types may include, but are not limited to, neural networks, random forests, generalized linear models, and Bayesian regression. Machine-learned model types are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameter surrounding a model is referred to as selecting the model “architecture”. Consequently, in many circumstances, a machine-learned model may be specified by indicating its type and associated hyperparameters.

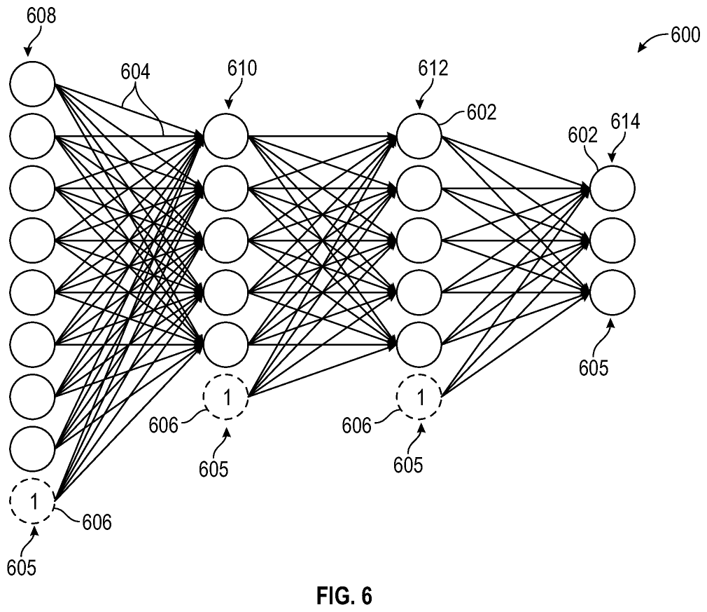

In one or more embodiments, the machine-learned model type of the machine-learned model (429) used in the flow rate signal enhancement system (304) is a neural network. A diagram of a neural network is shown in FIG. 6. At a high level, a neural network (600) may be graphically depicted as being composed of nodes (602), where here any circle represents a node, and edges (604), shown here as directed lines. The nodes (602) may be grouped to form layers (605). FIG. 6 displays four layers (608, 610, 612, 614) of nodes (602) where the nodes (602) are grouped into columns, however, the grouping need not be as shown in FIG. 6. The edges (604) connect the nodes (602). Edges (604) may connect, or not connect, to any node(s) (602) regardless of which layer (605) the node(s) (602) is in. That is, the nodes (602) may be sparsely and residually connected. A neural network (600) will have at least two layers (605), where the first layer (608) is considered the “input layer” and the last layer (614) is the “output layer”. Any intermediate layer (610, 612) is usually described as a “hidden layer”. A neural network (600) may have zero or more hidden layers (610, 612) and a neural network (600) with at least one hidden layer (610, 612) may be described as a “deep” neural network or as a “deep learning method.” In general, a neural network (600) may have more than one node (602) in the output layer (614). In this case the neural network (600) may be referred to as a “multi-target” or “multi-output” network.

Nodes (602) and edges (604) carry additional associations. Namely, every edge is associated with a numerical value. The edge numerical values, or even the edges (604) themselves, are often referred to as “weights” or “parameters”. While training a neural network (600), numerical values are assigned to each edge (604). Additionally, every node (602) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) ,$$

where i is an index that spans the set of “incoming” nodes (602) and edges (604) and ƒ is a user-defined function. Incoming nodes (602) are those that, when viewed as a graph (as in FIG. 6), have directed arrows that point to the node (602) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max (0,x), however, many additional functions are commonly employed. Every node (602) in a neural network (600) may have a different associated activation function. Often, as a shorthand, activation functions are described by the function ƒ by which it is composed. That is, an activation function composed of a linear function ƒ may simply be referred to as a linear activation function without undue ambiguity.

When the neural network (600) receives an input, the input is propagated through the network according to the activation functions and incoming node (602) values and edge (604) values to compute a value for each node (602). That is, the numerical value for each node (602) may change for each received input. Occasionally, nodes (602) are assigned fixed numerical values, such as the value of 1, that are not affected by the input or altered according to edge (604) values and activation functions. Fixed nodes (602) are often referred to as “biases” or “bias nodes” (605), displayed in FIG. 6 with a dashed circle.

In some implementations, the neural network (600) may contain specialized layers (605), such as a normalization layer, or additional connection procedures, like concatenation. One skilled in the art will appreciate that these alterations do not exceed the scope of this disclosure.

As noted, the training procedure for the neural network (600) comprises assigning values to the edges (604). To begin training the edges (604) are assigned initial values. These values may be assigned randomly, assigned according to a prescribed distribution, assigned manually, or by some other assignment mechanism. Once edge (604) values have been initialized, the neural network (600) may act as a function, such that it may receive inputs and produce an output. As such, at least one input is propagated through the neural network (600) to produce an output. Generally, a training dataset is provided the neural network for training. The training dataset is composed of inputs and associated target(s), where the target(s) represent the “ground truth”, or the otherwise desired output. The neural network (600) output is compared to the associated input data target(s). The comparison of the neural network (600) output to the target(s) is typically performed by a so-called “loss function”; although other names for this comparison function such as “error function” and “cost function” are commonly employed. Many types of loss functions are available, such as the mean-squared-error function, however, the general characteristic of a loss function is that the loss function provides a numerical evaluation of the similarity between the neural network (600) output and the associated target(s). The loss function may also be constructed to impose additional constraints on the values assumed by the edges (604), for example, by adding a penalty term, which may be physics-based, or a regularization term. Generally, the goal of a training procedure is to alter the edge (604) values to promote similarity between the neural network (600) output and associated target(s) over the data set. Thus, the loss function is used to guide changes made to the edge (604) values, typically through a process called “backpropagation”.

While a full review of the backpropagation process exceeds the scope of this disclosure, a brief summary is provided. Backpropagation consists of computing the gradient of the loss function over the edge (604) values. The gradient indicates the direction of change in the edge (604) values that results in the greatest change to the loss function. Because the gradient is local to the current edge (604) values, the edge (604) values are typically updated by a “step” in the direction indicated by the gradient. The step size is often referred to as the “learning rate” and need not remain fixed during the training process. Additionally, the step size and direction may be informed by previously seen edge (604) values or previously computed gradients. Such methods for determining the step direction are usually referred to as “momentum” based methods.

Once the edge (604) values have been updated, or altered from their initial values, through a backpropagation step, the neural network (600) will likely produce different outputs. Thus, the procedure of propagating at least one input through the neural network (600), comparing the neural network (600) output with the associated target(s) with a loss function, computing the gradient of the loss function with respect to the edge (604) values, and updating the edge (604) values with a step guided by the gradient, is repeated until a termination criterion is reached. Common termination criteria are: reaching a fixed number of edge (604) updates, otherwise known as an iteration counter; a diminishing learning rate; noting no appreciable change in the loss function between iterations; reaching a specified performance metric as evaluated on the data or a separate hold-out dataset. Once the termination criterion is satisfied, and the edge (604) values are no longer intended to be altered, the neural network (600) is said to be “trained.”

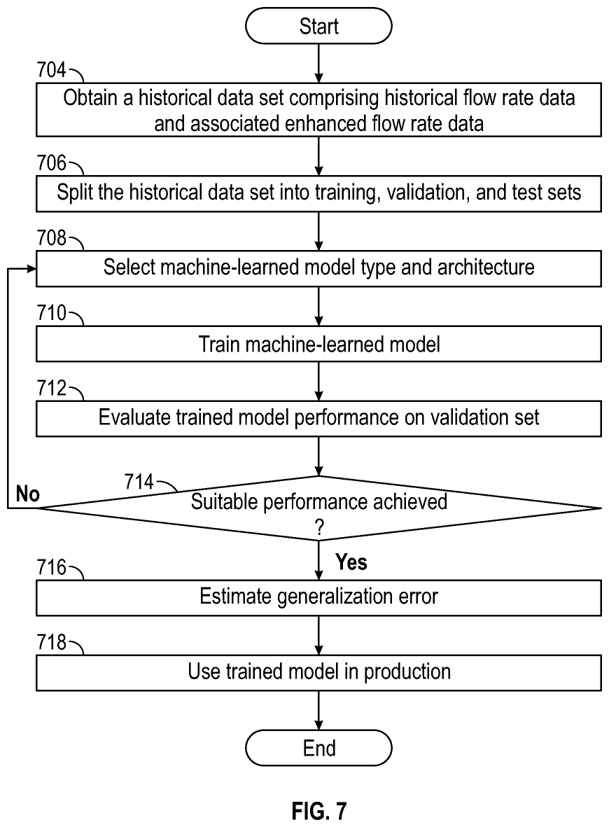

FIG. 7 depicts the general process of selecting and training a machine-learned model, in accordance with one or more embodiments. The process shown in FIG. 7 may be applied to train the machine-learned model (429) of the flow rate signal enhancement system (304).

To start, as shown in Block 704, a historical data set is received. The historical data set consists of input and target pairs. In one or more embodiments, the input is historical flow rate data and the associated target is enhanced flow rate data. In some embodiments, the input and target may consist of intervals of flow rate data and enhanced flow rate data where the flow rate signal enhancement system (304) would expect the data values over the intervals to be corrected by the machine-learned model (429). In some embodiments, the historical data may also include process variable data that can be supplied to the machine-learned model as an input.

In other words, in general, the historical data set consists of the expected input and desired output for the machine-learned model (429). In accordance with one or more embodiments, the historical data set is acquired from one or more existing wells and/or pipelines or from previously collected historical flow rate data. In one or more embodiments, the historical data set is preprocessed before being using to train, validate, and test the machine-learned model (429). Preprocessing, at a minimum, comprises altering the historical data set so that it is suitable for use with machine-learned models. For example, numericalizing categorical data (e.g., the process variable data describing the binary state of valves) or removing data entries with missing values. Other typical preprocessing methods are normalization and imputation. In these cases, information surrounding the preprocessing steps is saved for potential later use. For example, if normalization is performed then a computed mean vector and variance vector are retained. This allows future input data to be preprocessed identically. Values computed and retained during preprocessing are referred to herein as preprocessing parameters. One with ordinary skill in the art will recognize that a myriad of preprocessing methods beyond numericalization, removal of data entries with missing values, normalization, and imputation exist. Descriptions of a select few preprocessing methods herein do not impose a limitation on the preprocessing steps encompassed by this disclosure.

Returning to FIG. 7, as shown in Block 706, the historical data set is split into training, validation, and test sets. In some embodiments, the validation and test set may be the same such that the data is effectively only split into two distinct sets. In some instances, Block 706 may be performed before preprocessing. In this case, it is common to determine the preprocessing parameters, if any, using the training set and then to apply these parameters to the validation and test sets.

In Block 708, a machine-learned model type and associated architecture are selected. In one or more embodiments, various machine-learned model types and architectures are predefined in a list and the subsequent processes of FIG. 7 may be applied to each machine-learned model type and architecture pairing in order to discover the pairing with the best performance. Once the machine-learned model type and hyperparameters have been selected, the machine-learned model is trained using the training set of the historical data set according to Block 710. Common training techniques, such as early stopping, adaptive or scheduled learning rates, and cross-validation may be used during training without departing from the scope of this disclosure.

During training, or once trained, the performance of the trained machine-learned model is evaluated using the validation set as depicted in Block 712. Recall, that in some instances, the validation set and test set are the same. Generally, performance is measured using a function which compares the predictions of the trained machine-learned model to the given targets. A commonly used comparison function is the mean-squared-error function, which quantifies the difference between the predicted value and the actual value when the predicted value is continuous, however, one with ordinary skill in the art will appreciate that many more comparison functions exist and may be used without limiting the scope of the present disclosure.

Block 714 represents a decision: if the trained machine-learned model performance, as measured by a comparison function on the validation set (Block 712), is not suitable, the machine-learned model architecture may be altered (i.e., return to Block 708) and the training process is repeated. There are many mays to alter the machine-learned model architecture in search of suitable trained machine-learned model performance. These include, but are not limited to: selecting a new architecture from a previously defined set; randomly perturbing or randomly selecting new hyperparameters; using a grid search over the available hyperparameters; and intelligently altering hyperparameters based on the observed performance of previous models (e.g., a Bayesian hyperparameter search). Once suitable performance is achieved, the training procedure is complete and the generalization error of the trained machine-learned model(s) is estimated according to Block 716.

Generalization error is an indication of the trained machine-learned model's performance on new, or un-seen data. Typically, the generalization error is estimated using the comparison function, as previously described, using the historical data set that was partitioned into the test set.

As depicted in Block 718, the trained machine-learned model (429) is used “in production”—which means the trained machine-learned model (429) is used to process a received input without having a paired target for comparison (i.e., the trained machine-learned model is made available to and used by the flow rate signal enhancement system (304)). It is emphasized that the inputs received in the production setting, as well as for the validation and test sets, are preprocessed identically to the historical data set if preprocessing was applied before training.

While the various blocks in FIG. 7 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

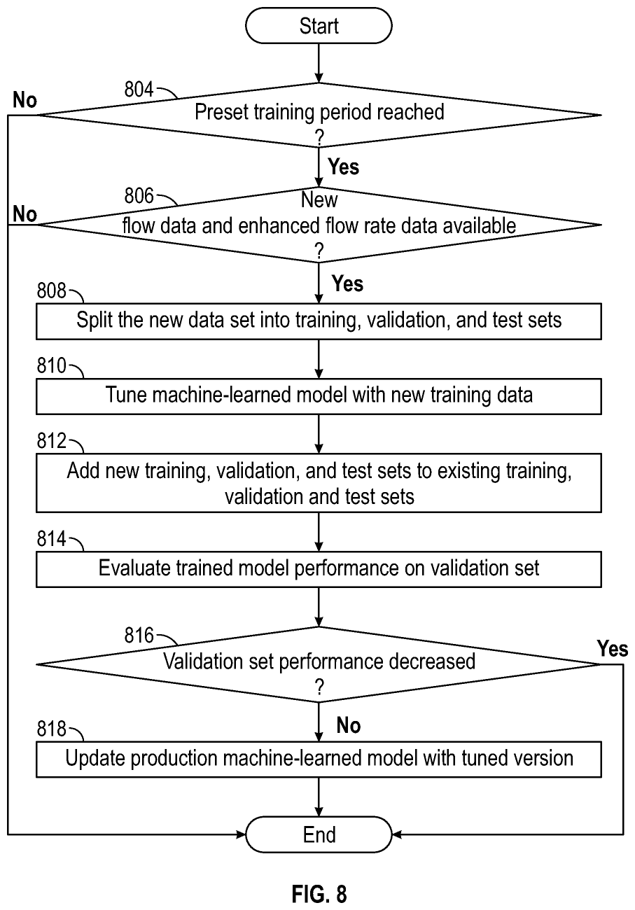

In accordance with one or more embodiments, the trained machine-learned model (429) is continuously or periodically updated (i.e., tuned) in the production setting using an online training loop (422). FIG. 8 depicts an online training loop in accordance with one or more embodiments. It is noted that there are many ways to implement an online training loop such that the steps depicted in FIG. 8 should not be considered limiting on the present disclosure. That is, one with ordinary skill in the art will readily recognize that various alterations may be applied to the steps of FIG. 8 without departing from the scope of this disclosure.

Keeping with FIG. 8, in Block 804 a check is performed to see if a pre-defined training period has been reached. A user may set the pre-defined training period. In one or more embodiments, the pre-defined training period is set to one week. The pre-defined training period is considered reached if the length of time determined by the pre-defined training period has passed since the last check of Block 804. That is, Block 804 essentially represents a scheduler where the remaining blocks are implemented every pre-defined training period. If the pre-defined training period has been reached, in Block 806 a check is performed to see if new flow rate data and associated enhanced flow rate data is available. In one or more embodiments, flow rate data and associated enhanced flow rate data is stored in a database (not shown). In one or more embodiments, the enhanced flow rate data may be obtained by applying the current version of the trained machine-learned model to the new flow rate data. In other embodiments, enhanced flow rate data is acquired by manual alteration of the flow rate data by a subject matter expert. The flow rate data and associated enhanced flow rate data is considered new if it has not been used previously train or tune (i.e., update) the machine-learned model (429).

If new flow rate data and associated enhanced flow rate data is available, the new data set is split into training validation and test sets in Block 808. In Block 810, the new training data is used to tune the current machine-learned model (429). Generally, tuning consists of training the machine-learned model (429) using the new training data starting from the current (or previously trained) parameters of the machine-learned model (429). In one or more embodiments, in Block 812 the new training, validation, and test sets are appended to the existing (or previously established) training, validation, and test sets respectively. Again, in one or more embodiments, the training, validation, and test sets are stored in a database (not shown).

In Block 814, the newly-tuned machine-learned model (429) is evaluated using the validation set. In some embodiments, the validation set includes the previously used validation set and the new validation set such that model is evaluated on all previously acquired validation data. In other embodiments, the validation set used to evaluate the newly-tuned machine-learned model (429) only consists of the new validation set. Still, in other embodiments, the validation set may include only validation data over a recent validation time period, where the validation time period is defined by a user. In this case, the model performance is continuously monitored using only recent data such to account for drift in received flow rate data.

In Block 816, a check is performed to see if the newly-tuned machine-learned model's performance has decreased. If the performance has not decreased, the machine-learned model (429) used in production (i.e., the machine-learned model used by the flow rate signal enhancement system (304)) is replaced by the newly-tuned machine-learned model in Block 818.

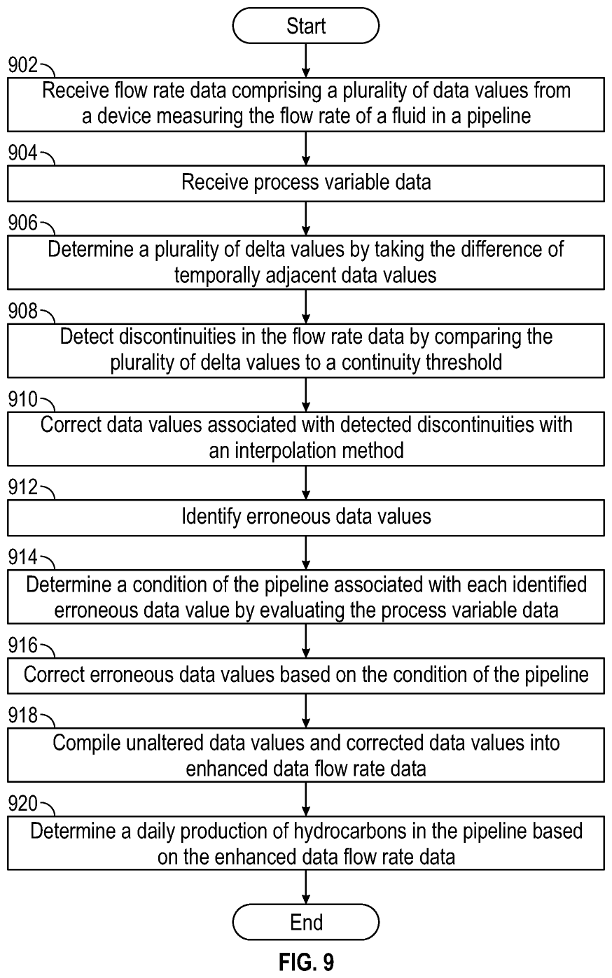

FIG. 9 depicts a flowchart outlining the flow rate signal enhancement system (304), in accordance with one or more embodiments. In Block 902, flow rate data that includes a plurality data values is received from a device that measures the flow rate of a fluid in a pipeline. The device may be a MPFM, VFM, test separator, or other device. The fluid may be a multiphase fluid. In the case of a multiphase fluid, the flow rate data may include phase flow rate measurements, or a measured flow rate for a single phase. In general, the pipeline is outfitted with field devices. These field devices are capable of measuring quantities and detecting states of various processes and devices associated with the pipeline. For example, field devices may include a SSV (107) and a choke valve (119) along with a method and/or mechanism for determining the state, open or closed, of the SSV (107) and choke valve (119). Further, the field devices may include an upstream pressure transducer capable of measuring the upstream pressure of the fluid. In one or more embodiments, measurements acquired from field devices is considered process variable data.

In Block 904, process variable data from the pipeline is received. Those skilled in the art will appreciate that process variable data may be included with the flow rate data such that Block 904 may be optional. In Block 906, a plurality of delta values is determined by taking the difference of temporally adjacent data values. In Block 908, each delta value in the plurality of delta values is compared to a continuity threshold in order to detect and identify intervals of discontinuities. In one or more embodiments, a positive continuity threshold and a negative continuity threshold are used during a comparison depending on if a given delta value is positive or negative.

In Block 910, an interpolation method is used to correct data values associated with the detected continuities. In one or more embodiments, the detected continuities can be grouped into one or more discontinuous intervals and the data values contained within the one or more intervals are replaced with interpolated values. In Block 912, erroneous data values are identified. Erroneous data values are identified through a series of enhanced heuristics outlined in FIG. 4. For example, data values with values less than or equal to zero obtained when the SSV (107) and choke valve (119) were in an open state and when an upstream pressure exceeded a first pressure threshold are determined to be erroneous. In Block 914, a condition of the pipeline is determined using the process variable data for each identified erroneous data value. Generally, the condition of the pipeline is defined by noting the state of the SSV (107) and choke valve (119) and the upstream pressure as measured by the upstream pressure transducer. That is, the condition of pipeline is determined by evaluating the process variable data.

Depending on the condition of the pipeline associated with a data value, or an interval of data values, erroneous data points are either corrected with the interpolation method or a machine-learned model, as depicted in Block 916. For example, for an interval of erroneous data values, if the condition of the pipeline includes the SSV (107) and choke valve (119) being in an open state, the upstream pressure being greater than a first pressure threshold, and the length of the interval being greater than a duration threshold, then the machine-learned model is used to correct the interval of erroneous data values. In Block 918, all of the data values, where each data value is either set to zero, unaltered, or corrected are compiled to from enhanced flow rate data.

In Block 920, the enhanced flow rate data is use to determine a daily production of hydrocarbons transported through the pipeline. Because the enhanced flow rate data corrects erroneous values in the original flow rate data, the accuracy of the daily production of hydrocarbons in improved.

Embodiments of the present disclosure may provide at least one of the following advantages. Use of the flow rate signal enhancement system (304) as described herein will improve hydrocarbon accounting. Typically, engineers that monitor oil and gas field production are required to aggregate the daily production from each well on daily basis and report that information to a hydrocarbon accounting system in order to close the production mass balance from all wells against the total production. This allows production to be tracked against corporate targets. By ensuring the flow rate data (or flow rate signal) is corrected instantaneously using flow rate signal enhancement system (304) with standardized steps and processes, hydrocarbon production is more accurately logged in the hydrocarbon accounting system. Continued improved accounting will lead to better estimation of a well's health, inform life cycle decisions, and improve the forecasted production estimates.

Another perceived advantage involves improving production compliance. Typically, petroleum engineers are interested in ensuring that a well's production meets a previously set target. These targets are set to meet demand and also maintain long-term reservoir health. The flow rate signal enhancement system (304) disclosed herein ensures better production compliance by reporting corrected aggregated flow rates over the production planning period.

Another advantage involves minimizing engineering hours. As mentioned, engineers monitor the flow rates (i.e., production signals) of one or more wells on daily basis and eventually report the aggregated daily production in the corporate accounting system. When encountered with signal loss or intervals of erroneous data, a manual correction process is typically applied using engineer-specific heuristics and rules of thumbs. Because the correction process is not standardized between engineers, corrected production signals can have significant variation depending on the engineer manually applying the correction. The flow rate signal enhancement system (304) described herein ensures that the correction and reporting process well production is implemented uniformly (i.e., standardized) across all wells. Further, the daily correction is performed instantaneously by the flow rate signal enhancement system (304) reducing engineering hours required to correct flow rate data manually. Thus, engineers can use the saved man-hours for tasks of higher value or tasks that require human intervention.

Finally, the flow rate signal enhancement system (304) improves flowmeter fault detection. Because the current process of signal error detection employs only simple heuristics or manual inspection, many erroneous signals can be passed unnoticed. The flow rate signal enhancement system (304) described herein, which couples advanced heuristics and a machine-learned model, can detect erroneous signals with greater accuracy and efficiency. Thus, faulty flow meters, or the flow rate measurement devices that consistently output erroneous flow rate data, are better identified and marked for service and/or maintenance. Further, in instances where a flow rate measurement device is only returning erroneous flow rate data, corrected values output from the machine-learned model (429) can be used as a substitute the erroneous data. Thus, the reception of accurate flow rate data is not interrupted due to faulty flow meters or during a period of flow meter maintenance improving data reliability and availability to external systems (e.g., reservoir simulator).

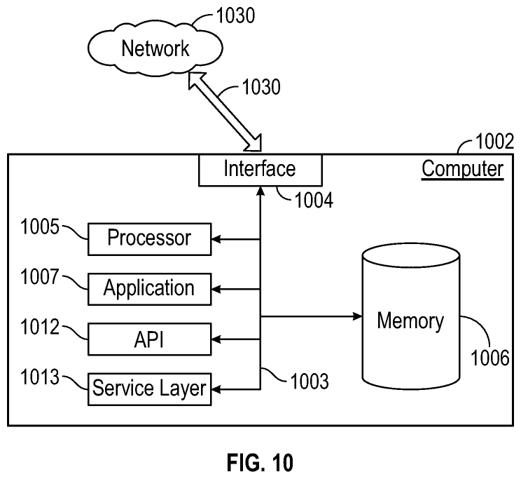

Embodiments may be implemented on a computer system. FIG. 10 is a block diagram of a computer system (1002) used to provide computational functionalities associated with described algorithms, methods, functions, processes, flows, and procedures as described in the instant disclosure, according to one or more embodiments. The illustrated computer (1002) is intended to encompass any computing device such as a server, desktop computer, laptop/notebook computer, wireless data port, smart phone, personal data assistant (PDA), tablet computing device, one or more processors within these devices, or any other suitable processing device such as an edge computing device, including both physical or virtual instances (or both) of the computing device. An edge computing device is a dedicated computing device that is, typically, physically adjacent to the process or control with which it interacts. For example, the machine-learned model (429) may be implemented on an edge computing device. Additionally, the computer (1002) may include a computer that includes an input device, such as a keypad, keyboard, touch screen, or other device that can accept user information, and an output device that conveys information associated with the operation of the computer (1002), including digital data, visual, or audio information (or a combination of information), or a GUI.

The computer (1002) can serve in a role as a client, network component, a server, a database or other persistency, or any other component (or a combination of roles) of a computer system for performing the subject matter described in the instant disclosure. In some implementations, one or more components of the computer (1002) may be configured to operate within environments, including cloud-computing-based, local, global, or other environment (or a combination of environments).

At a high level, the computer (1002) is an electronic computing device operable to receive, transmit, process, store, or manage data and information associated with the described subject matter. According to some implementations, the computer (1002) may also include or be communicably coupled with an application server, e-mail server, web server, caching server, streaming data server, business intelligence (BI) server, or other server (or a combination of servers).

The computer (1002) can receive requests over network (1030) from a client application (for example, executing on another computer (1002) and responding to the received requests by processing the said requests in an appropriate software application. In addition, requests may also be sent to the computer (1002) from internal users (for example, from a command console or by other appropriate access method), external or third-parties, other automated applications, as well as any other appropriate entities, individuals, systems, or computers.

Each of the components of the computer (1002) can communicate using a system bus (1003). In some implementations, any or all of the components of the computer (1002), both hardware or software (or a combination of hardware and software), may interface with each other or the interface (1004) (or a combination of both) over the system bus (1003) using an application programming interface (API) (1012) or a service layer (1013) (or a combination of the API (1012) and service layer (1013). The API (1012) may include specifications for routines, data structures, and object classes. The API (1012) may be either computer-language independent or dependent and refer to a complete interface, a single function, or even a set of APIs. The service layer (1013) provides software services to the computer (1002) or other components (whether or not illustrated) that are communicably coupled to the computer (1002). The functionality of the computer (1002) may be accessible for all service consumers using this service layer. Software services, such as those provided by the service layer (1013), provide reusable, defined business functionalities through a defined interface. For example, the interface may be software written in JAVA, C++, or other suitable language providing data in extensible markup language (XML) format or another suitable format. While illustrated as an integrated component of the computer (1002), alternative implementations may illustrate the API (1012) or the service layer (1013) as stand-alone components in relation to other components of the computer (1002) or other components (whether or not illustrated) that are communicably coupled to the computer (1002). Moreover, any or all parts of the API (1012) or the service layer (1013) may be implemented as child or sub-modules of another software module, enterprise application, or hardware module without departing from the scope of this disclosure.

The computer (1002) includes an interface (1004). Although illustrated as a single interface (1004) in FIG. 10, two or more interfaces (1004) may be used according to particular needs, desires, or particular implementations of the computer (1002). The interface (1004) is used by the computer (1002) for communicating with other systems in a distributed environment that are connected to the network (1030). Generally, the interface (1004) includes logic encoded in software or hardware (or a combination of software and hardware) and operable to communicate with the network (1030). More specifically, the interface (1004) may include software supporting one or more communication protocols associated with communications such that the network (1030) or interface's hardware is operable to communicate physical signals within and outside of the illustrated computer (1002).

The computer (1002) includes at least one computer processor (1005). Although illustrated as a single computer processor (1005) in FIG. 10, two or more processors may be used according to particular needs, desires, or particular implementations of the computer (1002). Generally, the computer processor (1005) executes instructions and manipulates data to perform the operations of the computer (1002) and any algorithms, methods, functions, processes, flows, and procedures as described in the instant disclosure.

The computer (1002) also includes a memory (1006) that holds data for the computer (1002) or other components (or a combination of both) that can be connected to the network (1030). The memory may be a non-transitory computer readable medium. For example, memory (1006) can be a database storing data consistent with this disclosure. Although illustrated as a single memory (1006) in FIG. 10, two or more memories may be used according to particular needs, desires, or particular implementations of the computer (1002) and the described functionality. While memory (1006) is illustrated as an integral component of the computer (1002), in alternative implementations, memory (1006) can be external to the computer (1002).

The application (1007) is an algorithmic software engine providing functionality according to particular needs, desires, or particular implementations of the computer (1002), particularly with respect to functionality described in this disclosure. For example, application (1007) can serve as one or more components, modules, applications, etc. Further, although illustrated as a single application (1007), the application (1007) may be implemented as multiple applications (1007) on the computer (1002). In addition, although illustrated as integral to the computer (1002), in alternative implementations, the application (1007) can be external to the computer (1002).

There may be any number of computers (1002) associated with, or external to, a computer system containing computer (1002), wherein each computer (1002) communicates over network (1030). Further, the term “client,” “user,” and other appropriate terminology may be used interchangeably as appropriate without departing from the scope of this disclosure. Moreover, this disclosure contemplates that many users may use one computer (1002), or that one user may use multiple computers (1002).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method to enhance flow rate data, comprising:
receiving flow rate data comprising a plurality of data values from a device measuring a flow rate of a fluid in a pipeline;
receiving process variable data;
identifying and correcting erroneous data values with a flow rate signal enhancement system configured to:
determine a plurality of delta values by taking the difference of temporally adjacent data values;
detect discontinuities in the flow rate data by comparing the plurality of delta values to a continuity threshold;
correct data values associated with detected discontinuities with an interpolation method;
identify the erroneous data values;
determine a condition of the pipeline associated with each identified erroneous data value by evaluating the process variable data;
correct erroneous data values based on the condition of the pipeline; and
compile unaltered data values and corrected data values into enhanced data flow rate data; and
determining a daily production of hydrocarbons in the pipeline based on the enhanced data flow rate data.

2. The method of claim 1, wherein the pipeline is configured with, at least, a surface safety value, a choke valve, and an upstream pressure transducer.

3. The method of claim 2, wherein the flow rate signal enhancement system corrects an interval of erroneous data values with a machine-learned model when the condition comprises:
the surface valve being in an open state;
the choke valve being in an open state;
an upstream pressure measured by the upstream pressure transducer being greater than a first pressure threshold; and
a duration of the interval is greater than a duration threshold.

4. The method of claim 2, wherein the flow rate signal enhancement system corrects an interval of erroneous data values with the interpolation method when the condition comprises:
the surface valve being in an open state;
the choke valve being in an open state;
an upstream pressure measured by the upstream pressure transducer being greater than a first pressure threshold; and
a duration of the interval is less than or equal to a duration threshold.

5. The method of claim 3, further comprising:
selecting a machine-learned model type and an architecture for use by the flow rate signal enhancement system;
training the machine-learned model with a training data set comprising historical flow rate data and paired enhanced flow rate data.

6. The method of claim 1, further comprising determining a health of a well using a reservoir simulator based on the daily production of hydrocarbons.

7. The method of claim 5, wherein the machine-learned model is a neural network.

8. The method of claim 1, wherein the device is a multiphase flow meter and the fluid is a multiphase fluid.

9. The method of claim 1, further comprising consolidating the flow rate data and displaying the enhanced flow rate data and the daily production of hydrocarbons using a supervisory control and data acquisition (SCADA) system.

10. The method of claim 5, wherein the machine-learned model is tuned according to a preset periodicity if new training data is available.

11. A non-transitory computer readable medium storing instructions executable by a computer processor, the instructions comprising functionality for:
receiving flow rate data comprising a plurality of data values from a device measuring a flow rate of a fluid in a pipeline;
receiving process variable data;
determining a plurality of delta values by taking the difference of temporally adjacent data values;
detecting discontinuities in the flow rate data by comparing the plurality of delta values to a continuity threshold;
correcting data values associated with detected discontinuities with an interpolation method;
identifying erroneous data values;
determining a condition of the pipeline associated with each identified erroneous data value by evaluating the process variable data;
correcting erroneous data values based on the condition of the pipeline;
compiling unaltered data values and corrected data values into enhanced data flow rate data; and
determining a daily production of hydrocarbons in the pipeline based on the enhanced data flow rate data.

12. The non-transitory computer readable medium of claim 11, wherein the pipeline is configured with, at least, a surface safety value, a choke valve, and an upstream pressure transducer.

13. The non-transitory computer readable medium of claim 12, an interval of erroneous data values is corrected with a machine-learned model when the condition comprises:
the surface valve being in an open state;
the choke valve being in an open state;
an upstream pressure measured by the upstream pressure transducer being greater than a first pressure threshold; and
a duration of the interval is greater than a duration threshold.

14. The non-transitory computer readable medium of claim 12, wherein an interval of erroneous data values is corrected with the interpolation method when the condition comprises:
the surface valve being in an open state;
the choke valve being in an open state;
an upstream pressure measured by the upstream pressure transducer being greater than a first pressure threshold; and
a duration of the interval is less than or equal to a duration threshold.

15. The non-transitory computer readable medium of claim 13, further comprising:
selecting a machine-learned model type and an architecture for use by the flow rate signal enhancement system;
training the machine-learned model with a training data set comprising historical flow rate data and paired enhanced flow rate data.

16. The non-transitory computer readable medium of claim 11, further comprising determining a health of a well using a reservoir simulator based on the daily production of hydrocarbons.

17. The non-transitory computer readable medium of claim 13, wherein the machine-learned model is a neural network.

18. The non-transitory computer readable medium of claim 11, wherein the device is a multiphase flow meter and the fluid is a multiphase fluid.

19. The non-transitory computer readable medium of claim 13, wherein the machine-learned model is tuned according to a preset periodicity if new training data is available.

20. A system, comprising:
an oil and gas field;
a flow metering device coupled, physically or virtually, to a pipeline in the oil and gas field, wherein the flow metering device measures a flow rate of a fluid in the pipeline and outputs the measured flow rate as flow rate data;
a computer communicably connected to the flow metering device and comprises:
one or more computer processors, and
a non-transitory computer readable medium storing instructions executable by a computer processor, the instructions comprising functionality for:
receiving the flow rate data comprising a plurality of data values;
receiving process variable data;
determining a plurality of delta values by taking the difference of temporally adjacent data values;
detecting discontinuities in the flow rate data by comparing the plurality of delta values to a continuity threshold;
correcting data values associated with detected discontinuities with an interpolation method;
identifying erroneous data values;
determining a condition of the pipeline associated with each identified erroneous data value by evaluating the process variable data;
correcting erroneous data values based on the condition of the pipeline;
compiling unaltered data values and corrected data values into enhanced data flow rate data; and
determining a daily production of hydrocarbons in the pipeline based on the enhanced data flow rate data.
